(19) United States
(12) Patent Application Publication
(10) Pub. No.: US 2019/0315073 A1
(43) Pub. Date: Oct. 17, 2019

(54) BELT SPLICING MACHINE

(71) Applicant: Wenzhou Honglong Industrial Equipment Manufacturing Co., Ltd., Wenzhou (CN)

(72) Inventor: Yi YANG, Wenzhou (CN)

(73) Assignee: Wenzhou Honglong Industrial Equipment Manufacturing Co., Ltd., Wenzhou (CN)

(21) Appl. No.: 16/024,743

(22) Filed: Jun. 30, 2018

(30) Foreign Application Priority Data
Apr. 12, 2018 (CN) 201810325302.4

(51) Int. Cl. B29C 65/00; B29C 65/18

(52) U.S. Cl. CPC B29C 66/855; B29C 65/18; B29C 66/81455; B29C 66/81611; B29C 66/90

(57) ABSTRACT

A belt splicing machine includes two pressing plates respectively arranged at an upper side and a lower side and opposite to each other. The pressing plate located at the upper side and the pressing plate located at the lower side are respectively mounted on a support located at the upper side and a support seat located at the lower side. A heating sheet, a clamping plate, and an airbag are successively arranged between the pressing plate located at the upper side and the support seat from bottom to top. The clamping plate is fixedly connected to the pressing plate. A connecting plate is arranged between the airbag and the clamping plate. The clamping plate is fixedly connected to the support seat. A plurality of elongated grooves are formed on the lower side surface of the connecting plate along its length direction.

### CROSS REFERENCE TO RELATED APPLICATIONS

This application is based upon and claims priority to Chinese Patent Application No. 201810325302.4, filed on Apr. 12, 2018, the entire content of which is incorporated herein by reference.

### TECHNICAL FIELD

The present invention relates to the technical field of belt splicing equipment, particularly to a belt splicing machine.

### BACKGROUND

The belt splicing machine is an equipment for connecting two belts by thermo-compression, so that the seamless connection of two separate belts can be realized.

Generally, the existing belt splicing machine includes an upper pressing plate and a lower pressing plate. The compression splice operation of the belt is completed between the upper pressing plate and the lower pressing plate. The upper pressing plate and the lower pressing plate are both provided with a heating sheet as a heat source.

### SUMMARY

The objective of the present invention is to provide a belt splicing machine with better performance and better compression splice quality of belt.

In order to achieve the above-mentioned objective, the technical solution of the present invention is as follows:

A belt splicing machine includes a pressing plate located at the upper side and a pressing plate located at the lower side. And two pressing plates are arranged opposite to each other. The pressing plate located at the upper side and the pressing plate located at the lower side are respectively mounted on a support seat located at the upper side and a support seat located at the lower side. A heating sheet, a clamping plate, and an airbag are successively arranged between the pressing plate located on the upper side and the support seat located at the upper side from bottom to top. A connecting plate is arranged between the airbag and the clamping plate. The clamping plate is fixedly connected to the support seat located at the upper side. A plurality of elongated grooves are formed on a lower side surface of the connecting plate along the length direction of the connecting plate. The elongated groove is provided with a spring corresponding to its length. The spring is arranged along the length direction of the elongated groove. The diameter of the spring is greater than the depth of the elongated groove. The belt splicing machine of the present invention is characterized in that a blanket is arranged on the compression splicing surface of each of the upper, and lower pressing plates respectively. The support seat located on the upper side is provided with an air inlet hole. The air inlet hole is provided with a filter screen. A fan is arranged inside the support seat located at the upper side. An air outlet port of the fan is arranged downwards. The left end of the support seat located at the upper side is provided with a first power source connecting terminal. The left end of the support seat located at the lower side is provided with a second power source connecting terminal. The first power source connecting terminal is electrically connected to the second power source connecting terminal through a wire. The right end of the support seat located at the upper side is provided with a control module for controlling the operation of the splicing machine.

Further, two ends of the clamping plate, in the width direction, are respectively provided with a protruding fence. The fence can limit the movement of the connecting plate in the width direction thereof. The fence is further provided with a riveting bar for limiting upward movement of the connecting plate.

Further, the heating sheet is arranged between the pressing plate and the clamping plate. The pressing plate, the clamping plate, and the heating sheet are arranged in parallel. The two ends in the width direction of the pressing plate are respectively bent towards the middle of the pressing plate to form a limiting portion for limiting the movement of the heating sheet in the width direction of the pressing plate. The limiting portion and the pressing plate form a U-shaped structure. One end of the pressing plate in the length direction is provided with a baffle plate. A plurality of notches spacing with each other are arranged on the limiting portion along the length direction of the pressing plate. The clamping plate is provided with a plurality of engaging plates which are perpendicular to the clamping plate. The engaging plates are arranged corresponding to the notches. Two ends of the clamping plate in the width direction extend into the U-shaped structure. One end of the clamping plate in the length direction is provided with a fixing plate corresponding to the baffle plate. The baffle plate and the fixing plate are respectively provided with connection holes. A bolt is arranged in the connection holes for fixedly connecting the baffle plate and the fixing plate. The end of the engaging plate extends upward to form the fence.

Further the connecting plate contains a protruded crossbeam in the middle along the length direction of the connecting plate. Two ends of the plate in the width, direction are respectively provided with a protruding fence. The crossbeam, and the fence form two elongated airbag accommodating space. The airbag is of an elongated shape. Each of the two airbag accommodating spaces accommodates one airbag.

Further, two ends of the airbag accommodating space in the length direction are respectively provided with an airbag clamping device. The airbag clamping device includes an upper clamping block and a lower clamping block. Raised clamping tooth are arranged on the clamping surfaces of both the upper clamping block and the lower clamping block respectively. The upper clamping block is fixedly connected to the lower clamping block by a bolt.

Further, the upper and lower sides of the spring abut against the connecting plate and the clamping plate, respectively.

Further, the connecting plate is an elongated-shaped plate, and the lower side surface of the connecting plate is provided with a plurality of division plates which are spaced and parallel with each other along the length direction of the connecting plate. The adjacent division plates are enclosed to form an elongated groove.

Further, the notch is divided into several sections by the limiting portion. Two ends of the pressing plate in the length direction each have a section of limiting portion provided with a division groove. The division groove divides the section of limiting portion into a plurality of clamping portions.

The present invention has the following advantages. Various parts of the belt splicing machine provided by the present invention are optimized to obtain better performance and better belt compression splice quality. Therefore, the compressed belt is flat, the process is efficient, the heat dissipation is fast, and the force applied is uniform, and a seamless connection of the belts can be realized.

### BRIEF DESCRIPTION OF THE DRAWINGS

FIG. 1 is a structural schematic view of the present invention.

FIG. 2 is a structural schematic view of a pressing plate located at the upper side, a heating sheet, and a clamping plate of the present invention.

FIG. 3 is a sectional view showing the structure of the pressing plate located at the upper side, the heating sheet, and the clamping plate of the present invention.

FIG. 4 is an exploded schematic view showing the structure of the pressing plate located at the upper side, the heating sheet, and the clamping plate of the present invention.

FIG. 5 is an enlarged view of part A in FIG. 4 of the present invention.

FIG. 6 is a structural schematic view showing the connection of the connecting plate, the clamping plate, and the pressing plate located at the upper side of the present invention.

FIG. 7 is a side view showing the connection of the connecting plate, the clamping plate, and the pressing plate located at the upper side of the present invention.

FIG. 8 is an exploded schematic view of the connecting plate, the clamping plate, and the pressing plate located at the upper side of the present invention.

FIG. 9 is a first structural schematic view showing an arrangement of an airbag of the present invention.

FIG. 10 is a second structural schematic view showing an arrangement of the airbag of the present invention.

FIG. 11 is a structural schematic view of an airbag clamping device of the present invention.

FIG. 12 is a structural schematic view of a support seat located at the upper side, a connecting plate, and a clamping plate of the present invention.

FIG. 13 is a structural schematic view of a lower side surface of a connecting plate of the present invention.

### DETAILED DESCRIPTION

The specific implementations of the present invention will be further described in detail below with reference to the drawings and embodiments. The following embodiments are intended to illustrate the present invention rather than limit the scope of the present invention.

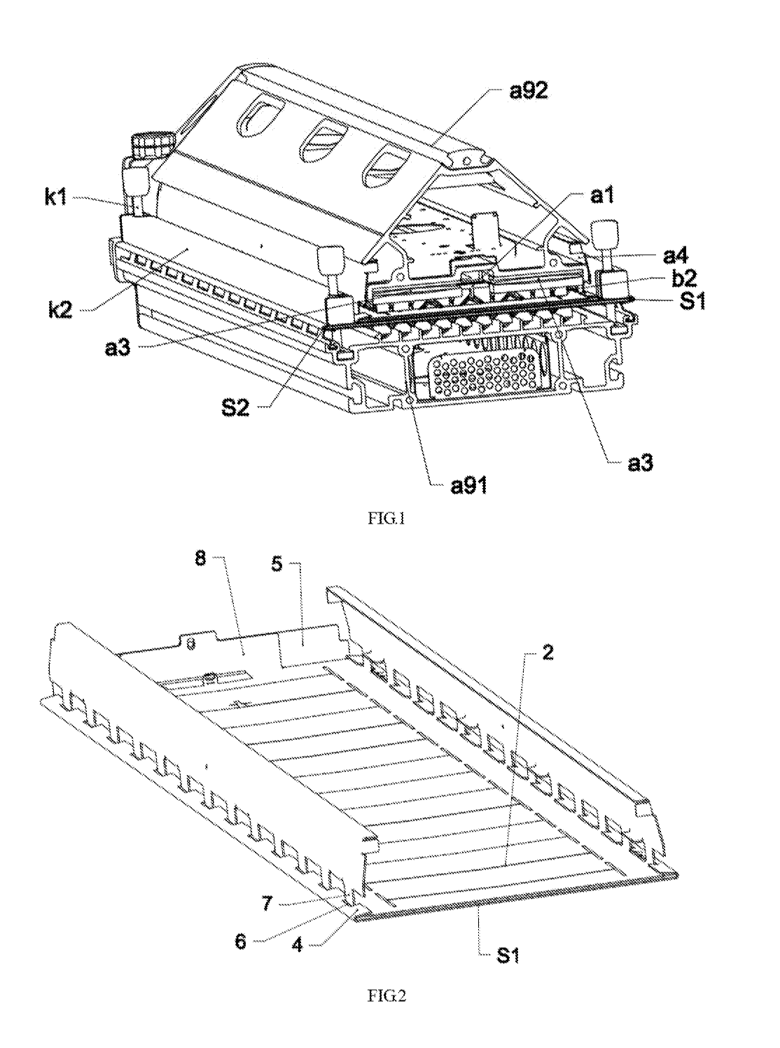

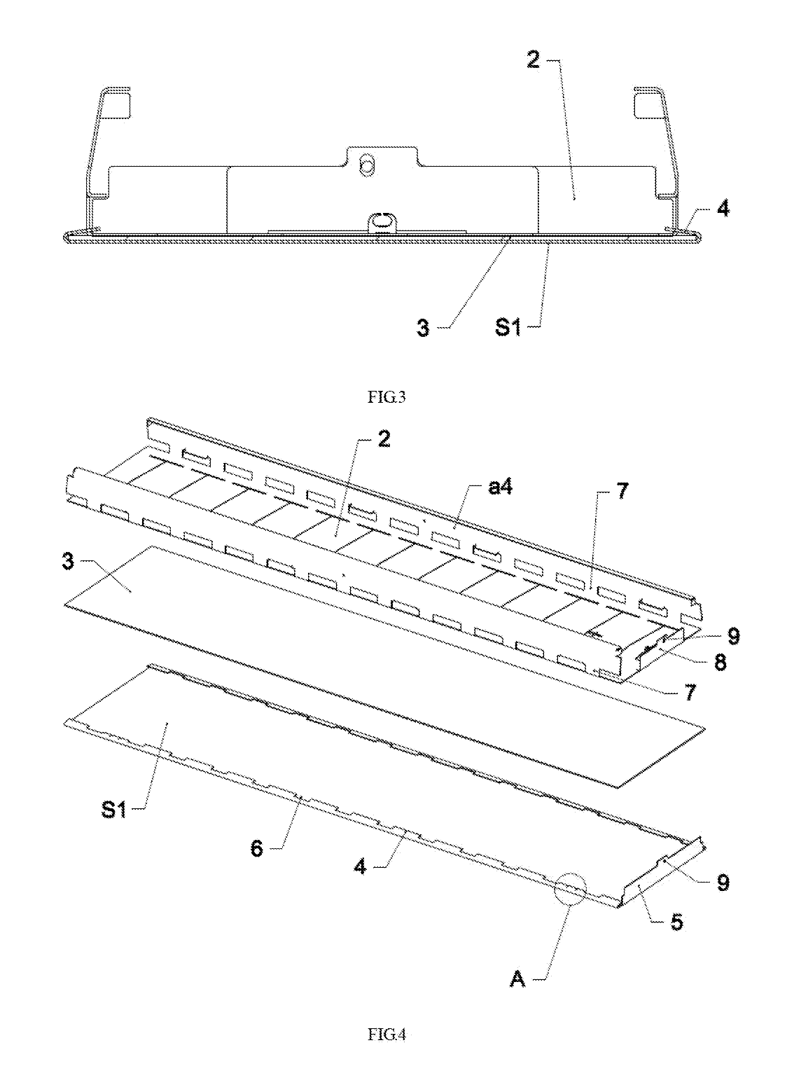

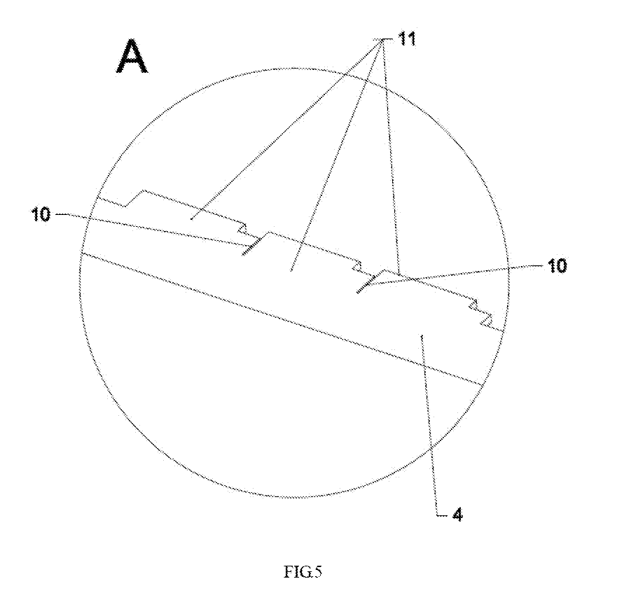

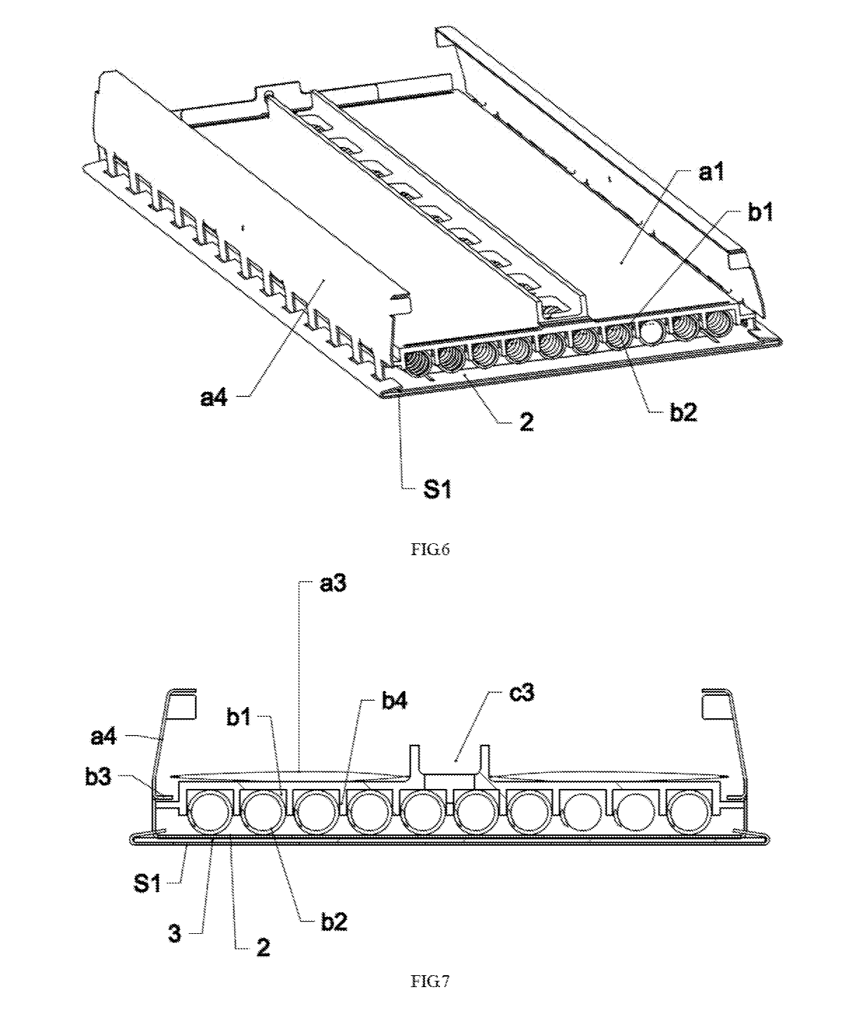

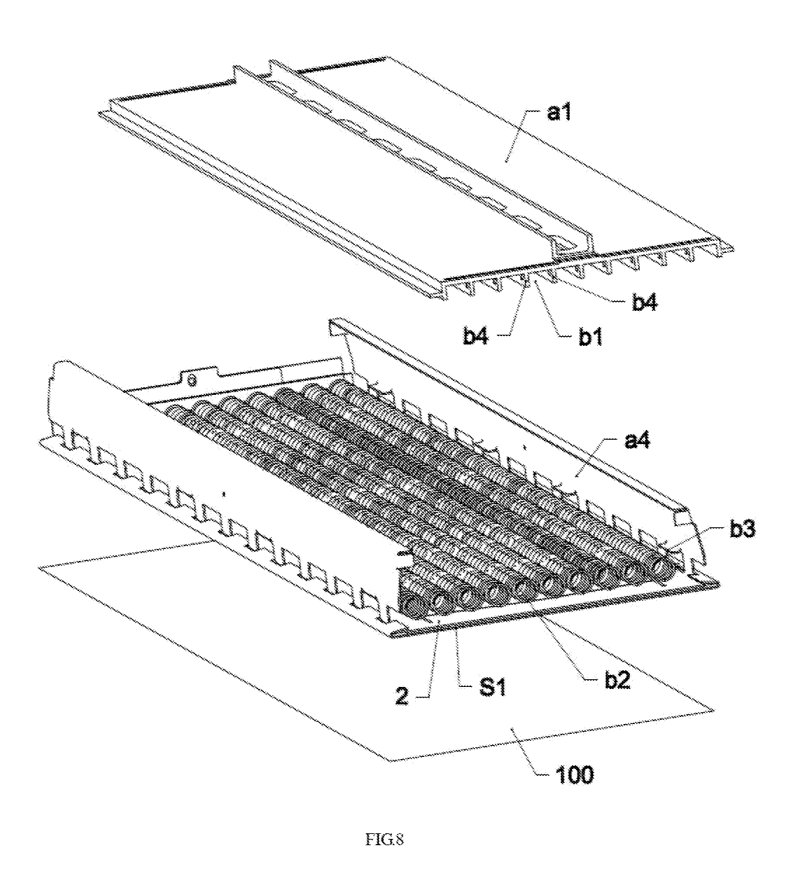

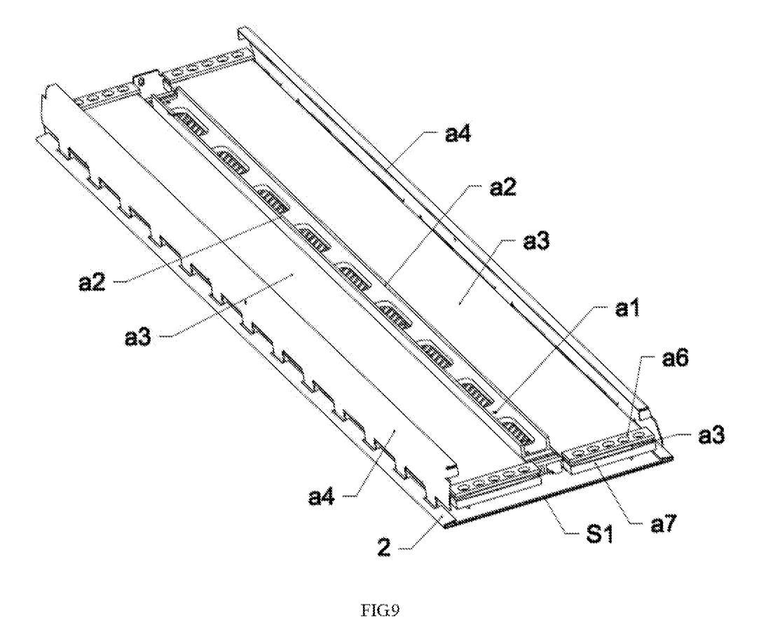

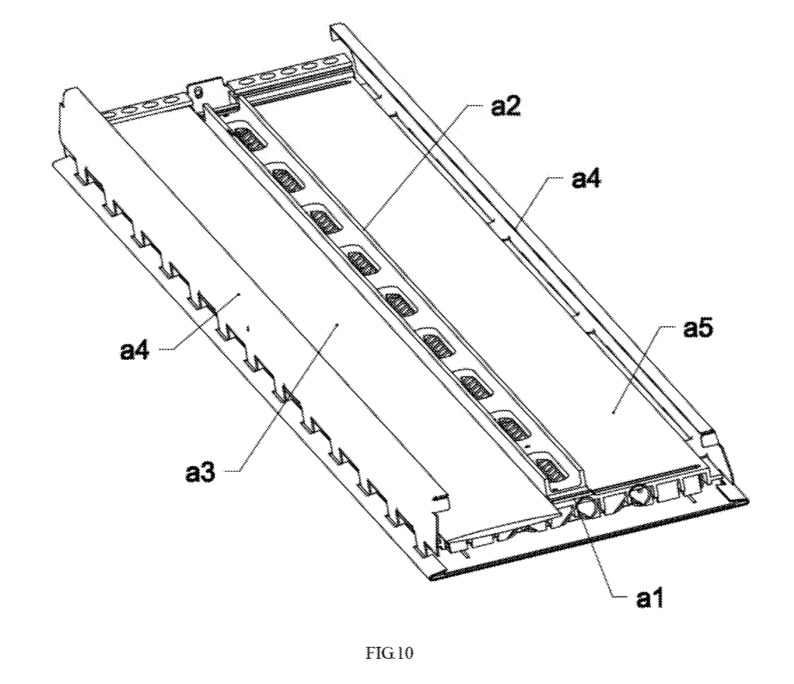

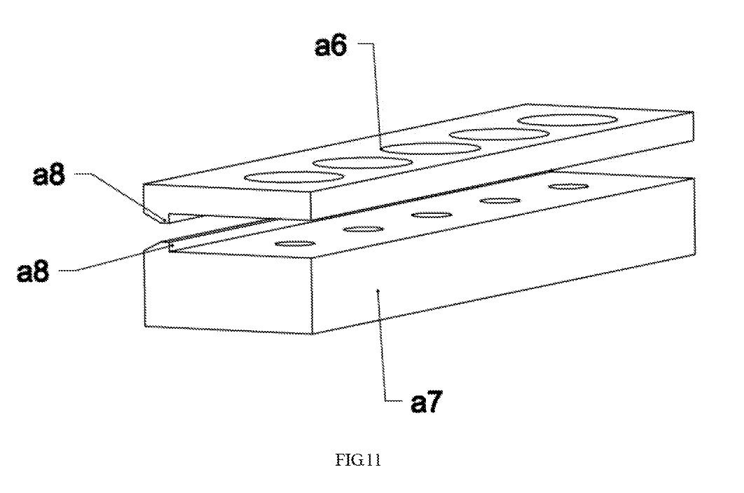

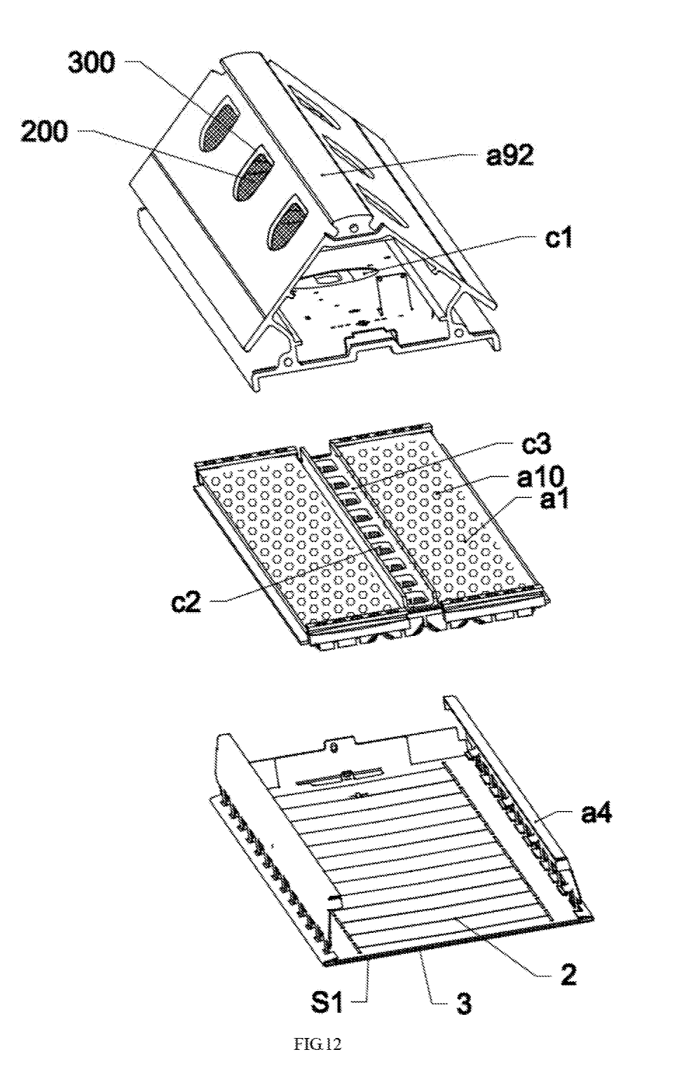

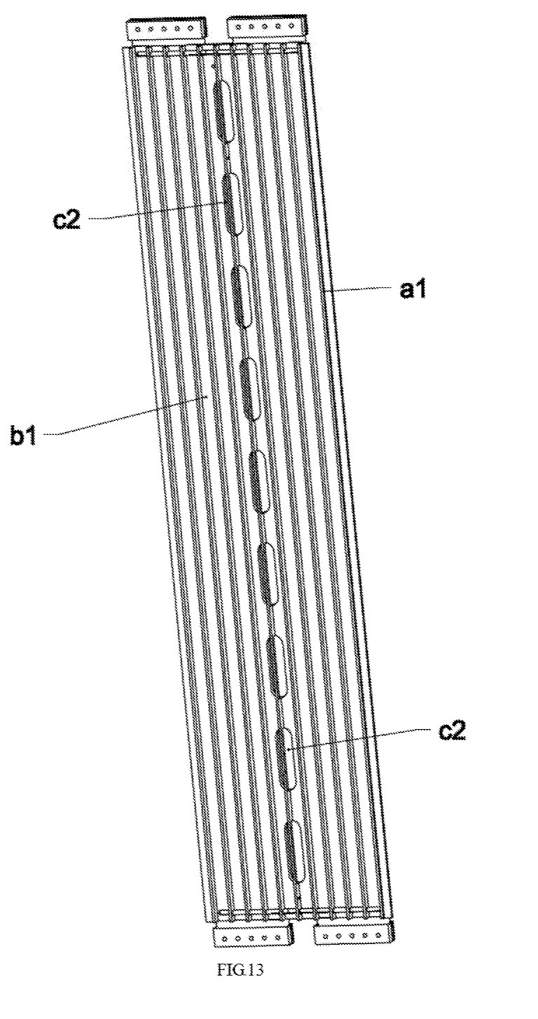

The present invention will be described below with reference to FIGS. 1 to 13.

A belt splicing machine includes a pressing plate located at the upper side and a pressing plated located at the lower side. And two pressing plates are arranged opposite to each other. The pressing plate located at the upper side and the pressing plate located at the lower side are mounted on a support seat located at the upper side and a support seat located at the lower side respectively The pressing plate located at the upper side is S1, the pressing plate located at the lower side is S2. The support seat located at the upper side is a92, the support seat located at the lower side is a91. The support seat a91 located at the lower side is provided with a vertical guiding rod k1. The support seat a92 located at the upper side is provided with a guiding seat k2 connected to the guiding rod k1. The guiding rod k1 cooperates with the guiding seat k2 to realize the belt, compressing action of two pressing plates 1.

The upper side surface of the pressing plate 1 located at the upper side is successively provided with a heating sheet 3, a clamping plate 2, and an airbag a3 from bottom to top. The clamping plate 2 is fixedly connected to the pressing plate 1. A connecting plate a1 is arranged between the airbag a3 and the clamping plate 2. The pressing-down action of clamping plate 2 is realized by inflating and deflating the airbag a3. A plurality of elongated grooves hi are formed on the lower side surface of the connecting plate a1, along the length direction of the connecting plate. A spring b2 corresponding to the length of the elongated groove is arranged in the elongated groove b1. The spring b2 is arranged along the length direction of the elongated groove b1. The diameter of the spring b2 is greater than the depth of the elongated groove b1, so that the upper and lower sides of the spring b2 can abut against the connecting plate a1 and the clamping plate 2, respectively. The pressure is transmitted through the spring b2. Two ends of the clamping plate 2 in the width direction are respectively provided with a protruding fence a4. The fence a4 abuts against two sides of the connecting plate a1 in the width direction. The fence a4 can limit the movement of the connecting plate a1 in the width direction thereof. A riveting bar b3 for limiting the upward movement of the connecting plate a1, is arranged on the fence a4. The riveting bar b3 is able to be bent and deformed.

The connecting plate a1 plays a role of an intermediate transferring member. The airbag is arranged at the upper side of the connecting plate a1. The spring b2 is arranged at the lower side of the connecting plate a1.

The connecting plate a1 is an elongated plate body, and a plurality of division plates b4 which are spaced and parallel with each other are arranged on the lower side surface of the connecting plate along the length direction. Adjacent division plates b4 are enclosed to form an elongated groove b1.

The support seat a92 located at the upper side is arranged above the airbag a3. The support seat a92 located at the upper side is fixedly connected to the fence a4.

By configuring the connecting plate a1, laying down spring b2, between the airbag a3 and the pressing plate 1, the force exerted downward by the connecting plate a1 is balanced through multiple springs b2, so that the force exerted on various parts of the pressing plate 1 is uniform, and the pressing plate 1 is able to keep balance during the downward pressure without deflection, thereby ensuring the flatness of the compressed belt.

The heating sheet 3 is arranged between the pressing plate 1 and the clamping plate 2. The pressing plate 1, the clamping plate 2, and the heating sheet 3 are arranged in parallel. The two ends of the pressing plate 1 in the width direction are respectively bent towards the middle of the pressing plate to form the limiting portion 4 for limiting the movement of the heating sheet 3 in the width direction of the pressing plate 1. The limiting portion 4 and the pressing plate 1 form a U-shaped structure. One end of the pressing plate 1 in length direction is provided with a baffle plate 5. The baffle plate 5 is used to limit the movement of the heating sheet in the length direction at one end. The limiting portion 4 is provided with a plurality of notches 6 spacing from each other along length direction of the pressing plate 1. A plurality of engaging plates 7, are perpendicular to the clamping plate, and are arranged on the clamping plate 2. The engaging plates 7 are arranged corresponding to the notches 6. In assembling, the engaging plate 7 is engaged with the notch 6. Two ends of the clamping plate 2 in the width direction extend into the U-shaped structure. One end of the clamping plate 2 in the length direction is provided with a fixing plate 8 corresponding to the baffle plate 5. The baffle plate 5 and fixing plate 8 are respectively provided with connection holes 9. A bolt for fixedly connecting the baffle plate and the fixing, plate is arranged in the connection holes 9. The end of the engaging plate 7 extends upward to form the fence a4.

The distal end of the bent limiting portion 4 will contact the heating sheet 3 first to clamp the heating sheet 3. However, if the front end of the limiting portion 4 is expected to contact and clamp the heating sheet 3, the limiting portion 4 should be bent with a greater angle, which is difficult. In the present invention, the front end of the limiting portion 4 clamps the clamping plate 2, so the front end of the limiting portion 4 can also indirectly clamp the heating sheet 3 even if the limiting portion is bent with a small angle.

The notch 6 is divided into several sections by the limiting portion 4. Two ends of the pressing plate 1 in the length direction each have a section of limiting portion 4 provided with a division groove 10. The section of limiting portion 4 is divided into a plurality of clamping portions 11 by the division groove 10. The clamping portion 11 may be further bent relative to the limiting portion 4. The clamping plate 2 is further tightly clamped and fixed at two ends of the clamping plate, so that the clamping plates are fixed more firmly.

The heating sheet 3 comes in close contact with the pressing plate 1 for better heat conduction.

The bending angle of the limiting portion 4 and the clamping portion 11 may be adjusted by applying force through a tool.

The heating sheet 3 is clamped and fixed by the pressing plate and the clamping plate 2. The U-shaped clamping and limiting structure formed at two ends of the pressing plate 1 in the width direction can completely limit the movement of the heating sheet 3 in the width direction of the pressing plate 1, and limit the clamping direction of the heating sheet 3 between the pressing plate 1 and the clamping plate 2 to a certain extent. The clamping plate 2 is also clamped in the U-shaped clamping structure. The movement of the clamping plate 2 in the clamping direction is also limited by the U-shaped clamping structure. Meanwhile, the engagement of the engaging plate 7 and the notch 6 can limit the movement of the clamping plate 2 in its width direction. The heating sheet 3 is fixed by the dual fixing means of the limiting portion 4 and the clamping plate 2, so that the heating sheet is fixed firmly, and the heat conduction is good.

The upper side surface of the pressing plate I located at the upper side is successively provided with the heating sheet 3, the clamping plate 2, and the airbag a3 from bottom to top. The clamping plate 2 is fixedly connected to the pressing plate 1, and the heating sheet 3 is clamped in between. A connecting plate a1 for accommodating the airbag a3 is arranged on the clamping plate 2. The connecting plate a1 is an elongated shape. A protruded crossbeam a2 is arranged in the middle of the connecting plate a1 along the lengthwise direction of the connecting plate. The two ends of the clamping plate 2 in the width direction are respectively provided with a protruding fence a4. The fence a4 is also fixedly connected to the support seat a92 located at the upper side. The crossbeam a2 and the fence a4 are enclosed to form two elongated airbag accommodating spaces a5. The airbag a3 is an elongated shape. The two airbag accommodating spaces a5 each accommodate an airbag a3. The airbag a3 is accommodated between the support seat a92 located at the upper side and the clamping plate 2.

The contact surface of the connecting plate a1 and the airbag a3 is a planar surface. The concavo-convex texture a10 may be provided on the contact surface, so that the contact of the airbag and the pressing plate is more stable without slippage.

Two ends of the airbag accommodating space a5 in the length direction are respectively provided with an airbag clamping device. The airbag clamping device is fixedly connected to the support seat a92 located at the upper side. The airbag clamping device includes an upper clamping block a6 and a lower clamping block a7. Raised clamping tooth a8 is arranged on the clamping surfaces of the upper clamping block a6 and the lower clamping block a7. The upper clamping block a6 is fixedly connected to the lower clamping block a7 by bolts.

Force is exerted upon the pressing plate 1 by the two airbags a3 to ensure that the force exerted to the entire pressing plate 1 is uniform and the quality of the compression splice of the belt is good. Since the middle of the airbag a3 will be expanded first and the edge of airbag a3 will be upturned after inflation, the resulting force exerted to the pressing plate 1 is not uniform to the edge. In the present application, the airbag a3 is distributed in the width direction of the pressing plate 1, so the force exerted to the pressing plate 1 is more uniform. More airbags a3 may also be configured to make the force exerted to the pressing plate 1 more uniform.

The support seat a92 located at the upper side is provided with an air hole c1. A fan (not shown) for blowing wind downward is mounted in the support seat a92 located at the upper side. A protruded crossbeam a2 is arranged on the middle of the upper side surface of the connecting plate al along the length direction of the connecting plate. An air inlet hole c2 which connects the upper and lower sides of the connecting plate a1 is arranged on the crossbeam a2. The air inlet hole c2 is arranged corresponding to the air hole c1.

An air groove c3 penetrating two ends of the crossbeam a2 in the length direction is formed in the middle of the crossbeam a2. The air inlet hole c2 is arranged at the bottom part of the air groove c3. A plurality of the air inlet holes c2 are arranged in the length direction of the connecting plate a1. The air groove c3 plays a role of shunting air which enables the air to evenly enter the air chamber, thereby avoiding the phenomenon of strong wind or weak wind at a single point.

The fan blows cool air to the space between the connecting plate a1 and the clamping plate 2 through the air inlet hole c2. Since the connecting plate a 1 cooperates with the clamping plate 2 with a distance in up and down manner, an air chamber is formed between the connecting plate a1 and the clamping plate 2. The cool air entering from the middle of the connecting plate a1 will flow around the entire air chamber, thereby bringing a good heat dissipation effect.

Blankets 100 are respectively arranged on the compression splicing surfaces of the pressing plates 1 located at the upper and lower sides. The blanket 100 between the pressing plate 1 and the belt plays a role of buffering and protecting the belt, so that the belt is prevented from being bruised and burned. The support seat a92 located at the upper side is provided with an air inlet hole 300. A filter screen 200 is arranged on the air inlet hole 300. A fan is arranged in the support seat a92 located on the upper side. The air outlet port of the fan faces downwards and is connected to the air hole c1. The filter screen 200 can prevent foreign matter from entering the interior of the equipment. The left end of the support seat located at the upper side is provided with a first power source connecting terminal. The left end, of the support seat located on the lower side is provided with a second power source connecting terminal. The first power source connecting terminal is electrically connected to the second power source terminal through a wire. The right end of the support seat located on the upper side is provided with a control module for controlling the operations of the splicing machine. Such an arrangement is convenient for the users to operate. Since the wire connecting terminal and the operation terminal are configured separately, the effects to operations caused by the messy wires can be avoided.

The foregoing descriptions are merely preferred implementations of the present invention. It should be noted that various improvements and modifications may be derived by those skilled in the art without departing from the technical principle of the present invention. The hypothetical improvements and modifications should also be considered to fall within the protection scope of the present invention.

1. A belt splicing machine comprising:
a pressing plate located at an upper side and a pressing plate located at a lower side, the pressing plate located at the upper side and the pressing, plate located at the lower side are arranged opposite to each other and are respectively mounted on a support seat located at an upper side and a support located at a lower side;
a heating sheet, a clamping plate, and an airbag successively arranged between the pressing plate located at the upper side and the support seat located at the upper side from bottom to top; wherein,
the clamping plate is fixedly connected to the pressing plate, a connecting plate is arranged between the airbag and the clamping plate, the clamping plate is fixedly connected to the support seat located at the upper side, a plurality of elongated grooves are formed on a lower side surface of the connecting plate along a length direction of the connecting plate, a spring corresponding to a length of the elongated groove is arranged in the elongated groove, the spring is arranged along a length direction of the elongated groove, a diameter of the spring is greater than a depth of the elongated groove;
wherein a compression splicing surface of each of the upper pressing plate and lower pressing plate is provided with a blanket, the support seat located at an upper side is provided with an air inlet hole, the air inlet hole is provided with a filter screen, a fan is arranged inside the support seat located at the upper side, an air outlet port of the fan faces downwards, a left end of the support seat located at the upper side is provided with a first power source connecting terminal, a left end of the support seat located at a lower side is provided with a second power source connecting terminal, the first power source connecting terminal is electrically connected to the second power source connecting terminal through a wire, and a right end of the support seat located at the upper side is provided with a control module for controlling operations of the belt splicing machine.

2. The belt splicing machine of claim 1, wherein:
two ends of the clamping plate in a width direction are respectively provided with a protruding fence, the fence limits a movement of the connecting plate in a width direction thereof, the fence is further provided with a riveting bar for limiting an upward movement of the connecting plate.

3. The belt splicing, machine of claim 1, wherein
the heating, sheet is arranged between the pressing plate and the clamping plate, the pressing plate, the clamping plate, and the heating sheet, are arranged in parallel;
two ends of the clamping plate in the width direction are respectively bent towards a middle of the pressing plate to form limiting portions for limiting a movement of the heating sheet in the width direction of the pressing plate;
the limiting portions and the pressing plate form a U-shaped structure, an end of the pressing plate in a length direction of the pressing plate is provided with a baffle plate;
the limiting portion is provided with a plurality of notches spaced from each other along the length direction of the pressing plate;
the clamping plate is provided with a plurality of engaging plates perpendicular to the clamping plate, the plurality of engaging plates are arranged corresponding to the plurality of notches;
two ends of the clamping plate in the width direction extend into the U-shaped structure;
an end of the clamping plate in the length direction is provided with a fixing plate corresponding to the baffle plate:
the baffle plate and the fixing plate are respectively provided with a connection hole;
a bolt is arranged in the connection hole for fixedly connecting the baffle plate and the fixing plate; and
an end of the engaging plate extends upward to form the protruding fence.

4. The belt splicing machine of claim 1, wherein:
the connecting plate is provided with a protruded crossbeam in a middle along the length direction of the connecting plate;
two ends of the clamping plate in the width direction are respectively provided with the protruding fence;
the crossbeam and the protruding fence are enclosed to form two elongated airbag accommodating spaces;
the airbag is of an elongated shape, and the two airbag accommodating spaces each accommodate one airbag.

5. The belt splicing machine of claim 4, wherein:
two ends of the airbag accommodating space in a length direction are respectively provided with an airbag clamping device;
the airbag clamping device comprises an upper clamping block and a lower clamping block;
clamping surfaces of the upper clamping block and the lower clamping block are respectively provided with a raised clamping tooth; and
the upper clamping block is fixedly connected to the lower clamping block by a bolt,

6. The belt splicing machine of claim 1, wherein
an upper side and a lower side of the spring abut against the connecting plate and the clamping plate, respectively.

7. The belt splicing machine of claim 1, wherein
the connecting plate is an elongated plate body;
the lower side surface of the connecting plate is provided with a plurality of division plates parallel and spacing with each other along the length direction of the connecting plate; and
adjacent division plates are enclosed to form the elongated groove.

8. The belt splicing machine of claim 3, wherein
the plurality of notches are divided into a plurality of sections by the limiting portion;
two ends of the pressing plate in the length direction each have a section of limiting portion provided with a division groove; and
the division groove divides the section of limiting portion into a plurality of clamping portions.

9. The belt splicing machine of claim 2, wherein
the heating sheet is arranged between the pressing plate and the clamping plate, the pressing plate, the clamping plate, and the heating sheet are arranged in parallel;
two ends of the clamping plate in the width direction are respectively bent towards a middle of the pressing plate to form limiting portions for limiting a movement of the heating sheet in the width direction of the pressing plate;
the limiting portions and the pressing plate form a U-shaped structure, an end of the pressing plate in a length direction of the pressing plate is provided with a baffle plate;
the limiting portion is provided with a plurality of notches spaced from each other along the length direction of the pressing plate;
the clamping plate is provided with a plurality of engaging plates perpendicular to the clamping plate, the plurality of engaging plates are arranged corresponding to the plurality of notches;
two ends of the clamping plate in the width direction extend into the U-shaped structure;
an end of the clamping plate in the length direction is provided with a fixing plate corresponding to the baffle plate;
the baffle plate and the fixing plate are respectively provided with a connection hole;
a bolt is arranged in the connection hole for fixedly connecting the baffle plate and the fixing plate; and
an end of the engaging plate extends upward to form the protruding fence.

10. The belt splicing machine of claim 2, wherein:
the connecting plate is provided with a protruded crossbeam in a middle along the length direction of the connecting plate;
two ends of the clamping plate in the width direction are respectively provided with the protruding fence;
the crossbeam and the protruding fence are enclosed to form two elongated airbag accommodating spaces;
the airbag is of an elongated shape, and the two airbag accommodating spaces each accommodate one airbag.

11. The belt splicing machine of claim 2, wherein
an upper side and a lower side of the spring abut against the connecting plate and the clamping plate, respectively.

12. The belt splicing machine of claim 2, wherein
the connecting plate is an elongated plate body.
the lower side surface of the connecting plate is provided with a plurality of division plates parallel and spacing with each other along the length direction of the connecting plate; and
adjacent division plates are enclosed to form the elongated groove.
